(19) United States
(12) Patent Application Publication
(10) Pub. No.: US 2009/0011775 A1
(43) Pub. Date: Jan. 8, 2009

(54) Supporting a Positioning of a Mobile Terminal

(76) Inventors: Jarko Niemenmaa, Espoo (FI); Sebastian Kraufvelin, Tenhola (FI); Ville Ruutu, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/224,274

(22) PCT Filed: Feb. 22, 2006
(86) PCT No.: PCT/IB2006/050573

§ 371 Date: Aug. 21, 2008

(51) Int. Cl. H04Q 7/20

(52) U.S. Cl. 455/456.1

(57) ABSTRACT

A positioning of a mobile terminal is of a type, which comprises evaluating measurements on received signals by a plurality of mobile terminals 110, 120, 130. The signals are transmitted by a plurality of base stations 201-205 of at least one cellular communication network. For supporting a positioning of a mobile terminal, mobile terminals 110, 120, 130 that are suitable for performing such measurements are determined based on available location data for mobile terminals. The location data is available independently from a positioning of the indicated type.

### FIELD OF THE INVENTION

The invention relates to a method for supporting a positioning of a mobile terminal. The positioning is of a type comprising evaluating measurements on received signals by a plurality of mobile terminals, which signals are transmitted by a plurality of base stations of at least one cellular communication network. The invention relates equally to a corresponding mobile location center, to a corresponding cellular communication network, to a corresponding cellular communication system, to a corresponding software code and to a corresponding software program product.

### BACKGROUND OF THE INVENTION

A known positioning method that has been standardized by the Third Generation Partnership Project (3GPP) for the Global System of Mobile Communication (GSM) is the Enhanced Observed Time Difference (E-OTD) approach. In the 3GPP standards for Wideband Code Division Multiple Access (WCDMA) based systems, E-OTD is referred to as Observed Time Difference of Arrival (OTDOA). E-OTD/OTDOA methods are also supported by the Secure User Plane Location (SUPL) solution standardized by the Open Mobile Alliance (OMA).

With E-OTD/OTDOA, a mobile terminal measures Observed Time Difference (OTD) values. These are the reception time differences between signals from respectively two base stations. The differences can be observed from certain repetitive parts of the signals, for example from the starts of synchronization bursts. The mobile terminal sends the OTD values to the network, where they are evaluated by an evaluation component like the Nokia iGMLC. In a 3GPP solution, the evaluation component is called Serving Mobile Location Center (SMLC), and in an OMA solution, the evaluation component is called SUPL Location Platform (SLP). The time difference of the transmissions at respectively two transmitting base stations is referred to as timing model or Real Time Differences (RTD) in GSM. If the RTDs between the involved base stations are known, then the Geographical Time Difference (GTD) values can be obtained by the evaluating component for a pair of base stations as GTD=OTD−RTD. A GTD value defines a hyperbola between those two base stations for which the OTD is measured and for which the RTD is available. With two or more such hyperbolas, the position of the mobile terminal can be estimated to be in the intersection of the hyperbolas.

The standardized E-OTD/OTDOA solutions rely on Location Measurement Units (LMU) to measure the required timing differences between base station transmissions. Since the base stations and the LMUs are located at known positions, the GTD for an LMU and a respective pair of base stations are known. An LMU may thus perform OTD measurements so that the RTD of the transmitting base stations can be calculated as RTD=OTD−GTD. It is a disadvantage of this solution that LMUs are required and that these LMUs involve considerable costs.

Cambridge Positioning Systems (CPS) developed an E-OTD/OTDOA positioning method called Matrix, which manages without LMUs.

Matrix uses measurements from other mobile terminals than the one that is to be positioned to replace the measurement information from LMUs. When two mobile terminals measure transmissions from five common base station sites, or when three mobile terminals measure transmissions from four common base station sites, it is possible to solve a group of equations and to obtain the locations of these mobile terminals and the desired RTD values.

Since cellular base station transmissions are relatively stable, if properly deployed, the RTD values are valid for a period of time called coherence period. Thus, it is possible that the network performs periodically anonymous Matrix operations to find out RTD values so that the required RTD values are available when a request for the position of a mobile terminal arrives.

The challenge with Matrix is to find two or three mobile terminals that are suited to measure transmissions from five or four common base station sites, in order to obtain valid RTD values for these base stations.

The position of a mobile terminal that has been determined in a preceding Matrix positioning is only of limited use as a basis for a selection. A mobile terminal may move during the ‘silence’ period, that is, during the time between the last positioning and the time when an RTD determination is needed. Requesting such a mobile terminal to perform OTD measurements is thus a useless procedure. On the other hand, there may be several Matrix capable mobile terminals in the area of interest, which are not known to be available. If a mobile terminal has not requested its own position, the positioning system is not aware of it. Another drawback is that the same mobile terminal may be disturbed frequently for timing model/RTD updates.

### SUMMARY OF THE INVENTION

The invention enhances a type of positioning, which requires measurements on received signals by a plurality of mobile terminals.

A method for supporting a positioning of a mobile terminal is proposed. The positioning is of a type, which comprises evaluating measurements on received signals by a plurality of mobile terminals. The signals are transmitted by a plurality of base stations of at least one cellular communication network. The method comprises determining an identity of a cell of a cellular communication network, which cell identity is associated to an area in which measurements on received signals by at least one mobile terminal are required. The method further comprises selecting at least one mobile terminal which is located in this area for providing measurements on received signals based on location data for the at least one mobile terminal. The location data is available independently from a positioning of this type.

Moreover, a mobile location center supporting a positioning of a mobile terminal is proposed. The positioning is of a type comprising evaluating measurements on received signals by a plurality of mobile terminals, which signals are transmitted by a plurality of base stations of at least one cellular communication network. The mobile location center comprises processing means adapted to determine an identity of a cell of a cellular communication network, which cell identity is associated to an area in which measurements on received signals by at least one mobile terminal are required. The mobile location center further comprises processing means adapted to select at least one mobile terminal which is located in this area for providing measurements on received signals based on location data for the at least one mobile terminal. The location data is available independently from a positioning of this type.

The mobile location center can be for instance a network element of a cellular communication network or be integrated in such a network element. Alternatively, it could be or belong to a device external to a cellular communication network.

The processing means can be realized in hardware and/or in software. The may comprise for instance corresponding software code and a processor executing this software code. Alternatively, they could be realized for instance by a circuit which is integrated in a chip.

Moreover, a communication network is proposed, which comprises the proposed mobile location center.

Moreover, a communication system is proposed, which comprises a plurality of mobile terminals and the proposed mobile location center.

Moreover, a software code for supporting a positioning of a mobile terminal is proposed. The positioning is of a type comprising evaluating measurements on received signals by a plurality of mobile terminals, which signals are transmitted by a plurality of base stations of at least one cellular communication network. When executed by a processor, the software code realizing the proposed method.

Finally, a software program product is proposed, in which the proposed software code is stored in a readable medium. The software program product can be for instance a separate memory device, a memory for implementation in a mobile location center that can be accessed by a processor for executing the stored software code, or a more comprehensive module for implementation in a mobile location center, etc.

The invention proceeds from the consideration that in most cellular communication networks, some information that is related to the location of mobile terminals is already available. Such information can be called passive location data, as it is not actively generated for the type of positioning that is to be supported. It is proposed to use available passive location data for an enhanced positioning solution. The passive location data is utilized to select mobile terminals that are likely to be suited for performing measurements in a selected area.

It is to be understood that a base station may be any kind of a wireless access point to a cellular communication network. It is further to be understood that a mobile terminal may be any device that is not fixed to a specific location and that is adapted to receive and measure signals from such an access point. It is further to be understood that a cellular communication network may be any kind of a network that is adapted to transmit data to a mobile terminal via at least one wireless access point.

It is an advantage of the invention that it facilitates the selection of suitable terminals for the required measurements. As a result, it also increases the likelihood and the speed of successful positioning operations.

It is also an advantage of the invention that it could be implemented without new hardware requirements on existing equipment.

The employed location data may be available for instance from a regular tracking of movements of mobile terminals accessing some cellular communication network. Some examples of such location data are location update information in the form of location areas, routing area information, for instance linked to the General Packet Radio Service (GPRS) STANDBY state, serving cell information, which is obtained during calls, short messages and handovers, etc.

Another example of available location data may be for instance network measurement reports (NMR) provided in GSM. These reports are transmitted by mobile devices to the network. They include the measured reception levels of signals from a serving base station and from neighboring base stations so that the network can decide to which cell a handover could be performed during a call. NMR may be considered as a possible type of passive location data, since it can be used for calculating location estimates.

Many cellular network standards, like GSM and WCDMA, further have specific support for Location Services (LCS). LCSs provide mechanisms and procedures to perform actions that provide a location estimate for a mobile device. For example, OMA SUPL supports delivery of signal strengths, namely “RX levels” to the SLP so that the location of a mobile device can be calculated.

Obviously, available location data is not reliable if it is too old or if it is of unknown age. In one embodiment of the invention, selecting at least one mobile terminal based on location data comprises therefore discarding location data that is older than a set threshold. The threshold may be fixed or variable. If it is variable, it may increase for instance with the size of a cell or of another area that is associated to a determined cell identity.

In one embodiment of the invention, selecting at least one mobile terminal for providing measurements on received signals comprises discarding mobile terminals, which do not support this type of positioning. In the case of 3GPP solutions, the terminal capabilities can be found for instance from class marks. In the case of OMA solution, a mobile terminal indicates it capabilities in the initial SUPL signaling with the network. In addition, a terminal management system, like the Nokia Terminal Management System (NTMS), can be used to find out whether a mobile terminal is suited for supporting the positioning.

In one embodiment of the invention, selecting at least one determined mobile terminal for providing measurements on received signals comprises discarding mobile terminals, which have recently been selected for providing measurements on received signals. That is, if many potential terminals are available, those that have been used recently are filtered out.

This allows avoiding that certain “anonymous” mobile terminals are overloaded with operations supporting the positioning of other mobile terminals. The invention is thus suited to reduce the load of a particular terminal, since the probability to find other suitable terminals is increased.

For enabling an evaluation which mobile terminals have recently been used, a record of mobile terminals, which have recently been selected for providing measurements on received signals, may be updated with the last selected mobile terminals. Such a record of terminals that have recently been used may be kept for instance by an SMLC or an SLP.

The measurements on received signals can be for instance measurements of OTDs of received signals. The OTDs may further be used for determining the Radio Interface Timing (RIT) of signals transmitted by a plurality of base stations of at least one cellular communication network. The RIT may then be stored for further use, for instance for the positioning of a mobile terminal. The determined RIT may comprise for instance determined RTDs or determined absolute time differences (ATD). If absolute time can be used for reference instead of RTD in a positioning, then ATD should be used.

The selection of suitable mobile terminals according to the invention can be performed at regular intervals and/or whenever measurements on received signals by at least one mobile terminal are required in a particular area, for example for a particular base station in this area.

Alternatively or in addition, mobile terminals may be selected in accordance with the invention upon a positioning request by a mobile terminal. In this case, the determined cell identity is an identity of a cell that is served by a serving base station of the requesting mobile terminal.

The base stations can be base stations of a cellular communication network of any type, for instance of a GSM or a WCDMA based cellular communication network. It has further to be noted that the mobile devices that are selected for performing the measurements on transmissions by these base stations do not necessarily have to be accessing the cellular communication network to which the base stations belong. For example, a mobile device could be connected to a network using WCDMA and location data for the mobile device could be available due to this connection. Still it could be selected for performing measurements on transmissions by second generation (2G) base stations, as long as the mobile device supports GSM as well. The most probable SUPL capable 3G mobile device supporting a 3G Matrix positioning, for example, is a dual mode mobile device. This means that this mobile device supports also GSM and second generation (2G) Matrix positioning. Even base stations, which are considered for measurements that are to be evaluated in common, could belong to different types of cellular communication networks. For example, a GSM/WCDMA enabled mobile device could measure OTD values between GSM base stations and OTDOA values between Node B:s, and it could even measure a combined OTD/OTDOA value between a 2G and a 3G base station.

### BRIEF DESCRIPTION OF THE FIGURES

Other objects and features of the present invention will become apparent from the following detailed description considered in conjunction with the accompanying drawings.

FIG. 1 is a schematic block diagram of a cellular communication system according to an embodiment of the invention;

FIG. 2 is a flow chart illustrating an operation in the system of FIG. 1.

### DETAILED DESCRIPTION OF THE INVENTION

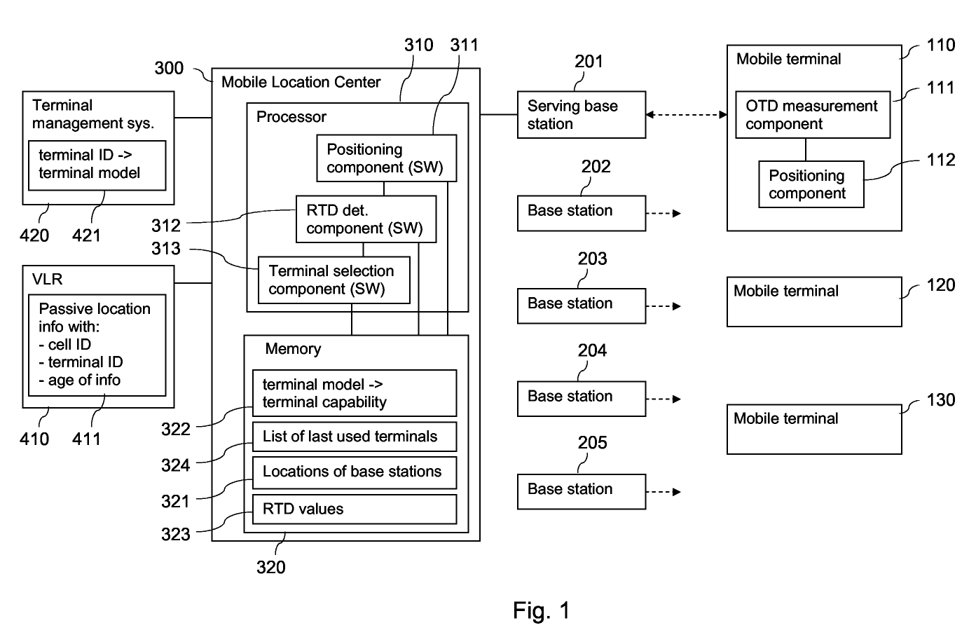

FIG. 1 is a schematic block diagram of an exemplary cellular communication system, in which an enhanced Matrix positioning according to an embodiment of the invention is implemented. The cellular communication system may be for instance a conventional GSM or a WCDMA system that has been supplemented in accordance with the invention.

The system comprises a plurality of mobile terminals 110, 120, 130. The mobile terminals 110, 120, 130 may be conventional mobile terminals. At least some of them are Matrix enabled. Each Matrix enabled mobile terminal 110 comprises an OTD measurement component 111 that is adapted to perform OTD measurements and a positioning component 112 that is adapted to manage a communication with a cellular communication network for enabling a positioning of the mobile terminal 110 and of other mobile terminals.

The system further comprises the cellular communication network.

The cellular communication network comprises a plurality of base stations 201, 202, 203, 204, 205, each serving mobile terminals 110-130 in at least one cell. To each cell, a cell identity (ID) is assigned.

The cellular communication network further comprises a mobile location center 300, for instance a 3GPP serving mobile location center SMLC. There may be a plurality of mobile location center 300 in the cellular communication network, each being responsible for an associated region.

The mobile location center 300 includes a processor 310 that is adapted to execute software code implemented in the mobile location center 300.

The implemented software code includes a positioning component 311. The positioning component 311 is adapted to perform a convention positioning of a mobile terminal based on provided OTD measurements from a mobile terminal 110, based on available RTD values for the transmissions of various base stations 201-205 and based on stored locations of these base stations 201-205.

The implemented software code further includes an RTD determination component 312. The RTD determination component 312 is adapted to perform a conventional RTD determination for a respective pair of base stations 201-205 based on OTD measurements from a plurality of Matrix enabled mobile terminals 110-130 and based on stored locations of various base stations 201-205.

The implemented software code includes in addition a terminal selection component 313. The terminal selection component 313 is adapted to select suitable mobile terminals 110-130, which are to provide OTD measurement results for a respective RTD determination by the RTD determination component 312, in accordance with an embodiment of the invention.

The mobile location center 300 further includes a memory 320. The memory 320 stores a database 321 with the known locations of those base stations 201-205, which are located in the region that is associated to the mobile location center 300. In addition, the memory 320 stores a database 322 with an association between various terminal models and their respective OTD measuring capability. The memory 320 further stores a database 323 with RTD values recently determined by the RTD determination component 312. For each base station 201-205, there may be a plurality of RTD values, for instance a respective RTD value for each neighboring base station. The memory 320 further stores a database 324 with a list of those mobile terminals that have recently been selected by the terminal selection component 313.

The processor 310 is able to access the databases 322-324 in the memory 320 upon request by any of the software code components 311, 312, 313.

The cellular communication network further comprises a VLR 410. The VLR 410 can be a conventional VLR. It stores a database 411 with passive location data for each mobile terminal 110-130 that is currently located in an associated region. The passive location data may comprise for each registered mobile terminal the cell ID of the cell, which is served by the current serving base station of the mobile terminal, a terminal ID of the mobile terminal and the time of the last update. Alternatively, the database 411 with passive location data could be stored in another element, such as the mobile location center 300. In this case, the VLR 410 could send passive location data to be stored to this other element.

The cellular communication network further comprises a terminal management system 420. The terminal management system 420 can be a conventional terminal management system, for instance a Nokia terminal management system. It stores the terminal model of each mobile terminal 110-130 that is registered in the cellular communication network.

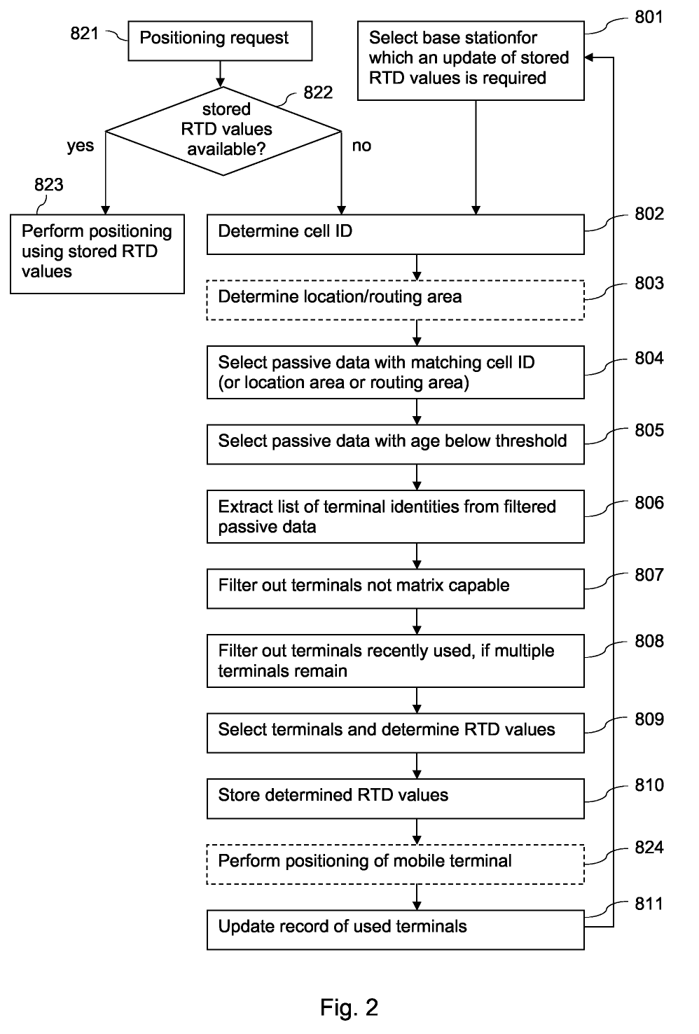

An operation in the system of FIG. 1 will now be described in more detail with reference to the flow chart of FIG. 2.

The RTD determination component 312 regularly updates the RTD values in database 323 for all base stations 201-205 for which the mobile location center 300 is responsible.

To this end, RTD determination component 312 determines a respective base station 201 for which an update of the stored RTD values is required. Then, it asks the terminal selection component 313 to provide the terminal ID of some mobile terminals that are suitable for providing OTD measurement results for this base station 201 (step 801).

The terminal selection component 313 determines thereupon the cell identity of the cell that is served by the base station 201 (step 802).

The terminal selection component 313 then requests passive location data from the VLR 410 or from another element including the database 411.

The terminal selection component 313 could retrieve for instance all available passive location data that includes the determined cell ID from the database 411. Alternatively, it could retrieve all available passive location data from the database 411 and then select itself the data that includes the determined cell ID (step 804).

As indicated above, the passive location data provided by a VLR 410 typically includes the cell ID and the terminal ID. In some cases, however, the passive location data could include only a location area or a routing area instead of the cell ID. Such an area may comprise several cells. In this case, first a location or routing area has to be determined that corresponds to the determined cell ID (step 803). Then, all passive location data is selected that comprises an indication of the determined location or routing area (step 804).

Next, the terminal selection component 313 filters the selected passive location data with regard to its age (step 805). The age of the passive location data should not exceed a threshold value. This threshold value could be fixed to a small value, like a couple of seconds. Alternatively, it could be set dynamically, for example based on the size of the considered cell. In the latter case, the threshold could be larger for large cells than for small cells. In any case, the threshold should be set such that it is not likely that a mobile terminal with passive location data having an age below this threshold value has moved in the meantime to another cell.

From the remaining passive location data, the terminal selection component 313 extracts the terminal IDs (step 806).

The terminal selection component 313 then checks whether the mobile terminals with the extracted terminal IDs are Matrix capable (step 807). From the terminal point of view, this is the same as being E-OTD or OTDOA capable. For checking the terminal capabilities, the terminal selection component 313 may obtain the model of each terminal from the terminal management system 420 based on the respective terminal ID. For each terminal model, the terminal selection component 313 may then look up the terminal capabilities in the database 322.

Only the Matrix capable mobile terminals are considered in the further processing.

In addition, the terminal selection component 313 checks whether any of the remaining mobile terminals has recently been used in a Matrix operation. The terminal IDs of these terminals are stored in the database 324. All terminals that have recently been used in a Matrix operation are discarded as well, in case sufficient terminals remain (808). Thereby, it is avoided that certain terminals, whose location is not needed but which are only used in obtaining RTD values, are loaded particularly with Matrix supporting operations.

Two or more of the remaining mobile terminals 110-130 are selected for determining RTD values for the selected base station 201 (step 809).

That is, the terminal IDs of these mobile terminals 110-130 are provided to the RTD determination component 312. The RTD determination component 312 triggers a request to each of these mobile terminals 110-130 via the respective serving base station. The request instructs the mobile terminals 110-130 to perform OTD measurements on signals received by the selected base station 201 and by neighboring base stations 202-205, and to provide the measurement results to the mobile location center 300.

The RTD determination component 312 receives the OTD measurement results. Based on these OTD measurement results and on the locations of the associated base stations 201-205 in the database 321, it determines the desired RTD values for the selected base station 201 in a conventional manner.

The determined RTD values are stored in the database 323 for future use together with the time of generation (step 810). The RTD values can be stored in instance in the form of a matrix.

Finally, the list of mobile terminals 120-130 in database 324 is updated with those mobile terminals 120-130 that had been selected for the OTD measurements (step 811).

In case the position of a mobile terminal 110 is to be determined by an initiative of the mobile terminal 110 itself, the positioning component 112 causes the OTD measurement component 111 to perform OTD measurements on signals received from the serving base station 201 and from at least two other base stations 202-205. The positioning component 112 then sends a positioning request together with the OTD measurement results via its serving base station 201 to the mobile location center 300. Upon receipt of the request (step 821), the positioning component 311 may now check whether any valid RTD values are available in the database 323 for the serving base station 201 (step 822). Whether available RTD values in the database 323 are still valid depends on the age of the RTD values.

If valid RTD values are available, the positioning component 311 uses the received OTD values and the RTD values 323 retrieved from the database 323 to calculate GTD values in a conventional manner. The GTD values may then be evaluated for determining the position of the mobile terminal 110 in a conventional manner (823).

If no valid RTD values are available, new RTD values may be determined as described above with reference to steps 802 to 811. In this case, the determined cell identity is the identity of the cell that is served by the serving base station 201 of the requesting mobile terminal 110. In this case, it may be sufficient to find one other suitable mobile terminal 120, 130 for performing measurements, since the measurements from the requesting mobile terminal 110 are available as well.

Once the RTD values have been determined in step 809, these values may be provided directly or via the database 323 to the positioning component 311. The positioning component 311 may then perform the positioning of the mobile terminal 110 in a conventional manner (step 824) based on the newly determined RTD values.

It is to be noted that the described embodiment constitutes only one of a variety of possible embodiments of the invention.

What is claimed:

1. A method comprising:
determining an identity of a cell of a cellular communication network, which cell identity is associated to an area in which measurements on received signals by at least one mobile terminal are required for supporting a positioning of a mobile terminal, wherein said positioning is of a type comprising evaluating measurements on received signals by a plurality of mobile terminals, which signals are transmitted by a plurality of base stations of at least one cellular communication network;
selecting at least one mobile terminal which is located in said area for providing measurements on received signals based on location data for said at least one mobile terminal, said location data being available independently from a positioning of said type.

2. The method according to claim 1, wherein said location data is available from a regular tracking of movements of mobile terminals accessing a cellular communication network.

3. The method according to claim 1, wherein said location data comprises at least one of:
location update information;
routing area information;
serving cell information; and
network measurement reports.

4. The method according to claim 1, wherein selecting at least one mobile terminal based on location data comprises discarding location data that is older than a set threshold.

5. The method according to claim 1, wherein selecting at least one mobile terminal for providing measurements on received signals comprises discarding mobile terminals, which do not support said type of positioning.

6. The method according to claim 1, wherein selecting at least one mobile terminal for providing measurements on received signals comprises discarding mobile terminals, which have recently been selected for providing measurements on received signals.

7. The method according to claim 6, further comprising updating a record of mobile terminals, which have recently been selected for providing measurements on received signals, with said at least one selected mobile terminal.

8. The method according to claim 1, wherein said measurements on received signals are measurements of observed time differences of received signals, said method further comprising using said observed time differences for determining the radio interface timing of signals transmitted by a plurality of base stations of at least one cellular communication network, and storing said radio interface timing for further use.

9. The method according to claim 1, further comprising performing said method at regular intervals and/or whenever measurements on received signals by at least one mobile terminal are required in a particular area.

10. The method according to claim 1, wherein said method is performed upon a positioning request by a mobile terminal and wherein said cell identity is an identity of a cell that is served by a serving base station of said mobile terminal.

11. The method according to claim 1, wherein said positioning type is a Matrix positioning.

12. An apparatus comprising a processor:
said processor being configured to determine an identity of a cell of a cellular communication network, which cell identity is associated to an area in which measurements on received signals by at least one mobile terminal are required for supporting a positioning of a mobile terminal, wherein said positioning is of a type comprising evaluating measurements on received signals by a plurality of mobile terminals, which signals are transmitted by a plurality of base stations of at least one cellular communication network; and
said processor being configured to select at least one mobile terminal which is located in said area for providing measurements on received signals based on location data for said at least one mobile terminal, said location data being available independently from a positioning of said type.

13. A communication network comprising an apparatus according to claim 12.

14. A communication system comprising a plurality of mobile terminals and an apparatus according to claim 12.

15. A software program product storing a software code in a readable medium, said software code realizing the following when executed by a processor:
determining an identity of a cell of a cellular communication network, which cell identity is associated to an area in which measurements on received signals by at least one mobile terminal are required for supporting a positioning of a mobile terminal, wherein said positioning is of a type comprising evaluating measurements on received signals by a plurality of mobile terminals, which signals are transmitted by a plurality of base stations of at least one cellular communication network;
selecting at least one mobile terminal which is located in said area for providing measurements on received signals based on location data for said at least one mobile terminal, said location data being available independently from a positioning of said type.

16. (canceled)

17. The apparatus according to claim 12, wherein said location data is available from a regular tracking of movements of mobile terminals accessing a cellular communication network.

18. The apparatus according to claim 12, wherein said location data comprises at least one of:
location update information;
routing area information;
serving cell information; and
network measurement reports.

19. The apparatus according to claim 12, wherein said selection of at least one mobile terminal based on location data comprises discarding location data that is older than a set threshold.

20. The apparatus according to claim 12, wherein said selection of at least one mobile terminal for providing measurements on received signals comprises discarding mobile terminals, which do not support said type of positioning.

21. The apparatus according to claim 12, wherein said selection of at least one mobile terminal for providing measurements on received signals comprises discarding mobile terminals, which have recently been selected for providing measurements on received signals.

22. The apparatus according to claim 21, said processor being further configured to update a record of mobile terminals, which have recently been selected for providing measurements on received signals, with said at least one selected mobile terminal.

23. The apparatus according to claim 12, wherein said measurements on received signals are measurements of observed time differences of received signals, said processor being further configured to use said observed time differences for determining the radio interface timing of signals transmitted by a plurality of base stations of at least one cellular communication network, and to store said radio interface timing for further use.

24. The apparatus according to claim 12, said processor being configured to determine an identity of a cell and to select a mobile terminal at regular intervals and/or whenever measurements on received signals by at least one mobile terminal are required in a particular area.

25. The apparatus according to claim 12, said processor being configured to determine an identity of a cell and to select a mobile terminal upon a positioning request by a mobile terminal and wherein said cell identity is an identity of a cell that is served by a serving base station of said mobile terminal.

26. The apparatus according to claim 12, wherein said positioning type is a Matrix positioning.

27. The apparatus according to claim 12, wherein said apparatus is a mobile location center or an apparatus for a mobile location center.

28. An apparatus comprising:
means for determining an identity of a cell of a cellular communication network, which cell identity is associated to an area in which measurements on received signals by at least one mobile terminal are required for supporting a positioning of a mobile terminal, wherein said positioning is of a type comprising evaluating measurements on received signals by a plurality of mobile terminals, which signals are transmitted by a plurality of base stations of at least one cellular communication network; and
means for selecting at least one mobile terminal which is located in said area for providing measurements on received signals based on location data for said at least one mobile terminal, said location data being available independently from a positioning of said type.
